(19) United States
(12) Patent Application Publication
(10) Pub. No.: US 2007/0090034 A1
(43) Pub. Date: Apr. 26, 2007

(54) Substrate for a chromatography column

(75) Inventors: Robert Dallas Ricker, Middletown, DE (US); John J. Harland, Hockessin, DE (US); Alan D. Broske, West Chester, PA (US); Wu Chen, Newark, DE (US); Bernard John Permar, Middletown, DE (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: Agilent Technologies, Inc., Palo Alto, CA (US)

(21) Appl. No.: 11/254,565

(22) Filed: Oct. 20, 2005

(51) Int. Cl. B01D 15/08

(52) U.S. Cl. 210/198.2; 502/407; 428/402

(57) ABSTRACT

A substrate for retaining a particulate packing medium within a chromatography column is disclosed. The substrate is formed from a polymer material and positionable to retain the packing medium within the column. The polymer has pores sized to retain the packing medium within the column but allow fluid, such as transport liquid or carrier gas to pass through. A method of forming the substrate within the column is also disclosed. The method includes placing a polymer precursor into the column and then polymerizing it to form the substrate.

### BACKGROUND

High performance liquid chromatography (HPLC) is a process by which one or more compounds from a chemical mixture may be separated and identified. Chromatography columns are used for any type of separation where a sample is loaded and eluted from the column in order to obtain separation of one or more components. Examples include analysis columns for identifying constituents, preparation columns for separating constituents prior to analysis and guard columns which protect analysis columns by separating out impurities before they can contaminate the analysis column.

In a particular example of an analysis column, a transport liquid, such as a solvent, is pumped under high pressure through a column of packing medium, and a sample of the chemical mixture to be analyzed is injected into the column. As the sample passes through the column with the liquid, the different compounds, each one having a different affinity for the packing medium, move through the column at different speeds. Those compounds having greater affinity for the packing medium move more slowly through the column than those having less affinity, and this speed differential results in the compounds being separated from one another as they pass through the column.

The transport liquid with the separated compounds exits the column and passes through a detector, which identifies the molecules, for example by spectrophotometric absorbance measurements. A two dimensional plot of the detector measurements against elution time or volume, known as a chromatogram, may be made, and from the chromatogram the compounds may be identified.

For each compound, the chromatogram displays a separate curve or “peak”. Effective separation of the compounds by the column is advantageous because it provides for measurements yielding well defined peaks having sharp maxima inflection points and narrow base widths, allowing excellent resolution and reliable identification of the mixture constituents. Broad peaks, caused by poor column performance, are undesirable as they may allow minor components of the mixture to be masked by major components and go unidentified.

An HPLC column typically comprises a thick walled stainless steel tube having a bore containing a packing medium comprising, for example, silane derivatized silica spheres having a diameter less than 50 microns. The medium is packed in highly uniform layers which ensure a uniform flow of the transport liquid and the sample through the column to promote effective separation of the sample constituents. The packing medium is contained within the bore by porous plugs, known as “frits”, positioned at opposite ends of the tube. The porous frits allow the transport liquid and the chemical sample to pass while retaining the packing medium within the bore.

The frits can adversely affect column performance because they add volume to the column that does not have packing medium to ensure uniform fluid flow. The additional volume creates space that permits mixing of the transport liquid and the sample. It is desired that the transport liquid and the sample mixture move through the column with as little mixing as possible so as to provide effective separation of the sample constituents. The volume added by the presence of the frits may cause transport liquid mixing that measurably degrades the column performance as evidenced by broadening of the chromatogram peaks and a concomitant decrease in the resolving capability of the HPLC apparatus. Smaller columns are generally more sensitive to this effect because volume added by a frit constitutes a larger percentage of the total column volume.

Additionally, the frits can adversely affect the chemistry of the column because they are formed of a material different from that of the packing medium. When a different material, for which the sample constituents may have affinities different from the affinities for the packing medium, is introduced within the column, it can disrupt the separation of the sample constituents.

It would be advantageous to have a low volume frit that does not substantially adversely affect the column's chemistry.

### SUMMARY OF THE INVENTION

The invention concerns a substrate for retaining a particulate packing medium within a chromatography column. The column has an opening. The substrate comprises a polymer material positionable to retain the packing medium within the column. The polymer material has pores sized to retain the packing medium within the column but permit fluid to pass therethrough.

The invention also concerns a method of forming a porous substrate in a column for chromatography. The substrate retains a packing medium within the column but allows fluid to pass therethrough. The method comprises:
placing a polymer precursor into the column;
curing the polymer precursor, the cured polymer forming the substrate.

### BRIEF DESCRIPTION OF THE DRAWING

FIG. 1 is a longitudinal sectional view of a chromatograph column having frits according to the invention.

### DETAILED DESCRIPTION

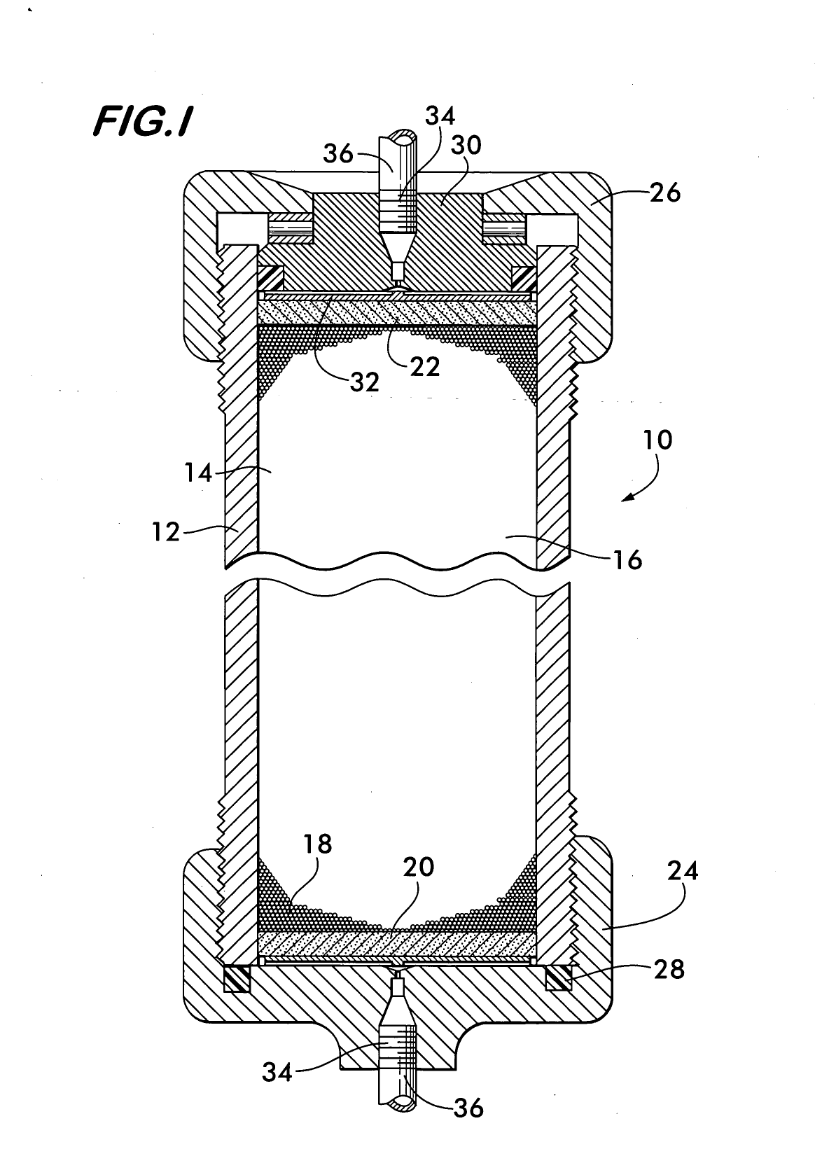

FIG. 1 shows an exemplary column 10 for liquid chromatography. Column 10 could be any type of chromatography column, including an analytical column, a preparatory column or a guard column, may comprise micro-fluidic devices formed from etched polymers (such as the HPLC Chip manufactured by Agilent Technologies Inc.) and may be formed from various materials such as fused silica, stainless steel, glass lined stainless steel, or stainless steel capillary lined with coated fused silica. The liquid chromatography column described herein is chosen by way of example for illustrative purposes only, it being understood that the invention is also applicable to columns for gas chromatography, solid phase extraction, spin tubes for preparation or separation, capillary electrophoresis and capillary electrochromatography.

Column 10 comprises a tube 12 having a bore 14 defining a chamber 16 for containing a packing medium 18. The packing medium may comprise for example silica particles or silane derivatized silica spheres having a diameter less than 50 microns and as small as 0.5 microns.

Packing medium 18 is retained within the bore 14 by porous substrates 20 and 22 positioned in spaced apart relation and preferably at opposite ends of the tube 12. The porosity of the substrates is such that the packing medium 18 is retained within the bore but chromatography transport liquid (or other fluids such as carrier gas for gas chromatography) and any fluid sample (liquid or gas) for analysis is permitted to pass through the column 10. Substrates 20 and 22 are supported within bore 14 by end fittings 24 and 26 that are preferably threadedly engaged with the tube. The fittings may seal directly to the tube as illustrated for fitting 24, which incorporates a seal 28 between the tube and the fitting to ensure fluid tightness. Alternately, as shown for fitting 26, a movable piston 30 may be incorporated that provides for adjustment of the position of the substrate 22 within the bore 14. This allows the compression on the packing medium 18 to be adjusted by rotating the fitting 26 to compensate for decreasing column performance as the packing medium degrades over time. Column performance may also be improved by positioning flow distribution disks 32 between the fittings 24 and 26 and the porous substrates 20 and 22 respectively to retard the development of a parabolic velocity distribution of fluid flow through the bore. Note that both end fittings 24 and 26 have openings 34 adapted to receive capillary tubing 36 for connecting the column to a liquid chromatograph apparatus.

Porous substrates 20 and 22 are formed from organic or inorganic polymers. For example, silica particles may be polymerized by the addition of a tri-functional silane such as tri-chloroalkyl silane, tri-methoxyalkyl silane, tri-ethoxyalkyl silane, tri-propoxyalkyl silane and mixtures thereof. Alternately an orthosilicate may be used to polymerize silica particles comprising the packing medium. Example orthosilicates include alkyl orthosilicate and tetraethyl orthosilicate and mixtures thereof. Furthermore, an acrylate may also be used to polymerize the packing medium. Such acrylates include ethyl acrylate, propyl acrylate, methyl methacrylate, ethyl methacrylate, ethyl 3,3-dimethylacrylate, ethyl 2-ethylacrylate, ethyl 2-propylacrylate and mixtures thereof.

In one example embodiment, the substrates comprise the silica particles of the packing medium polymerized by the addition of tetraethyl orthosilicate (Si(OC₂H₅)₄), known by its acronym TEOS. TEOS polymerizes to form a unitary substrate that naturally has pores on the order of 20-30 angstroms in diameter. Polyethylene glycol may be added to facilitate the formation of macro-pores on the order of 0.5 microns to about 2 microns advantageous for liquid chromatography columns.

In another embodiment, TEOS, or other organic polymer precursors may be used without the particles comprising the packing medium to form the substrates 20 and 22. TEOS is preferred when silica based packing medium is used because it has the least adverse effect on the chemistry of the column. To further mitigate any adverse effect on the column chemistry, the substrate itself may be derivatized after polymerization so that its chemistry is identical to that of the packing medium.

Other organic polymer precursors, such as methacrylate, acrylamide and styrene divinyl benzene, may be added to the packing medium along with a pore creating additive to form the substrates 20 and 22. Silica particles may be mixed with the organic polymer precursors and then, after the mixture has cured, the silica particles are dissolved out of the substrate using a strong base such as sodium hydroxide or ammonium hydroxide, leaving pores approximately the size of the particles. The functional pore size for the substrates, i.e., the pore size that will block packing medium particles but allow fluids such as transport liquid or carrier gas to pass through, may have an average size between about 0.5 microns and about 20 microns.

For larger analytical columns having an inner diameter between about 1 mm and 4.6 mm it is convenient to form porous polymer material into sheets and cut the substrates 20 and 22 from the sheets and then assemble them into the columns. For smaller analytical columns having a diameter between 25 microns and 500 microns it is advantageous to form the substrates within the column because it is difficult to manipulate substrates of such small size. This may be accomplished in any one of several ways described below.

In one method of forming the substrate in situ, a sintered stainless steel frit is positioned at one end of the column and the column is packed with packing medium. The column is then filled with a highly viscous fluid such as glycerol and a predetermined amount of TEOS or other organic polymer precursor is placed in the column, for example by injecting it at the opposite end from the stainless steel frit. The glycerol traps the TEOS or other polymer precursor at the end of the column where it polymerizes with the particles of the packing medium to form the porous substrate. The glycerol is removed after the substrate has cured. Polymerization is effected by controlling the pH of the TEOS. It is preferred that the frit 20 at the outlet of the column comprise the polymer substrate as any remixing caused by this frit has the greatest adverse effect on column performance since the sample constituents are separated when they reach the outlet frit, and mixing action at this point will negate the function of the column. The thickness of the substrate is controlled by the amount of TEOS injected. Preferred frit thicknesses range between about 5 microns and about 250 microns for columns with diameters between 25 and 500 microns, although frits of this thickness may show improved performance for columns having inner diameters as large as 1 mm. Frit thicknesses as great as 2500 microns are also thought practical for larger diameter columns.

In another method of preparing a substrate in situ, a polymer precursor is placed in the bore of the column and allowed to cure to form the frit 20 preferably at the outlet of the column. The substrate is then supported by attachment of the fitting 24, and the column can then be packed with packing medium 18, and the frit 22 at the opposite end may be inserted and supported by fitting 26. Alternately, the polymer precursor can be placed in the column to form the frit 22 as well. Regardless of the method used, it may be necessary to effect several injections of the polymer precursors and build up the frit to the required size in several steps due to polymer shrinkage upon curing.

Various polymers, such as TEOS, polystyrene divinyl benzene, and polyacrylamide, polyacrylate and polymethacrylate may be used with or without pore creating additives to form the substrate comprising the frit or frits. Polymethacrylate may be used in conjunction with packing medium to form the substrate by injecting the polymethacrylate into the column with packing medium therein to adhere the medium. Then the medium is dissolved away, leaving a porous substrate with pores approximately the size of the packing medium. Silica packing medium is preferred and it is dissolved using a strong base, such as sodium hydroxide or ammonium hydroxide, injected into the column. Upon formation of the substrate, the column is cleaned and packed with packing medium.

While particular column embodiments are described herein, they are for illustrative purposes only and not meant to limit the scope of the invention. Chromatography columns may have any shape and a wide range of sizes and operating parameters. For example, column embodiments according to the invention may have inner diameters that range from 25 microns to 25 mm and outer diameters between 375 microns and 30 mm or greater. The column length may vary between several centimeters up to a meter or more in length. Operating pressures may be between 50 bar and as high as 1000 bar and flow rates between 100 nl/min and 50 ml/min are feasible.

What is claimed is:

1. A substrate for retaining a particulate packing medium within a chromatography column, said column having an opening, said substrate comprising:
a polymer material comprising a polymerized portion of said packing medium positionable to retain said packing medium within said column, said polymer material having pores sized to retain said packing medium within said column and permit fluid to pass therethrough.

2. A substrate according to claim 1, wherein said polymer material comprises silica particles polymerized by the addition of a tri-functional silane.

3. A substrate according to claim 2, wherein said tri-functional silane is selected from the group consisting of tri-chloroalkyl silane, tri-methoxyalkyl silane, tri-ethoxyalkyl silane, tri-propoxyalkyl silane, and mixtures thereof.

4. A substrate according to claim 1, wherein said polymer material comprises silica particles polymerized by the addition of an orthosilicate.

5. A substrate according to claim 4, wherein said orthosilicate is selected from the group consisting of alkyl orthosilicate, tetraethyl orthosilicate, and mixtures thereof.

6. A substrate according to claim 1, wherein said polymer material comprises particles polymerized by the addition of an acrylate.

7. A substrate according to claim 6, wherein said acrylate is selected from the group consisting of ethyl acrylate, propyl acrylate, methyl methacrylate, ethyl methacrylate, ethyl 3,3-dimethylacrylate, ethyl 2-ethylacrylate, ethyl 2-propylacrylate, and mixtures thereof.

8. A substrate according to claim 1, wherein said polymer material comprises a compound selected from the group consisting of tetraethyl orthosilicate, polymethacrylate, polyacrylamide, polyacrylate and polystyrene divinyl benzene.

9. A column for chromatography, said column adapted to contain a particulate packing medium, said column comprising:
a chamber having first and second openings for allowing fluid to pass therethrough;
first and second substrates positioned to retain said packing medium within said chamber, at least one of said substrates comprising polymer material formed from polymerizing a portion of said packing medium, said substrates having pores sized to retain said packing medium within said chamber and allow fluid to pass therethrough.

10. A column according to claim 9, further comprising first and second fittings attached to said chamber in overlying relation with said first and second openings respectively, said fittings being adapted to connect said column to a chromatograph.

11. A column according to claim 9, wherein said chamber comprises a tube having a longitudinal bore therethrough, said bore adapted to contain said packing medium.

12. A column for chromatography, said column comprising:
a chamber;
a packing medium comprising particles contained within said chamber;
a substrate positioned within said chamber, said substrate formed from polymerized particles of said packing medium, said substrate having pores sized to retain said packing medium within said chamber while allowing fluid to pass therethrough.

13. A column according to claim 12, wherein said chamber comprises a tube having a longitudinal bore adapted to contain said packing medium.

14. A column according to claim 12, wherein said substrate comprises silica particles polymerized by the addition of a compound selected from the group consisting of a tri-functional silane, an orthosilicate and an acrylate.

15. A column according to claim 12, wherein said particles comprise silane derivatized silica spheres.

16. A column according to claim 13, wherein said column comprises a first and a second of said substrates positioned in spaced apart relation.

17. A column according to claim 16, wherein said substrates are positioned at opposite ends of said tube.

18. A column according to claim 17, further comprising first and second fittings positioned at said opposite ends of said tube, said fittings each having an opening therein and being adapted for connection to a chromatograph, said first and second fittings supporting said first and second substrates respectively.

19. A column according to claim 12, wherein said substrate is between about 5 microns and about 2500 microns thick.

20. A column according to claim 12, wherein said substrate has an average functional pore size between about 0.5 microns and about 20 microns.

21. A method of forming a porous substrate in a chromatography column, said substrate retaining a particulate packing medium within said column but allowing fluid to pass therethrough, said method comprising:
placing a polymer precursor into said column;
curing said polymer precursor to form a polymer, said cured polymer forming said substrate, said substrate having pores sized to retain said packing medium within said column and allow fluid to pass therethrough.

22. A method according to claim 21, further comprising:
placing a packing medium in said column; and
wherein said polymer precursor comprises a polymerizing compound, said polymerizing compound polymerizing a portion of said packing medium, said polymerized portion of said packing medium forming said substrate.

23. A method according to claim 21, further including mixing said polymer precursor with said particulate packing medium, and dissolving said packing medium from said polymer thereby forming said pores in said substrate.

24. A method according to claim 21, wherein said polymer precursor comprises a compound selected from the group consisting of a tri-functional silane, an orthosilicate and an acrylate.

25. A method according to claim 21, further comprising injecting a viscous fluid into said column and then injecting said polymerizing compound into said column, said viscous fluid trapping said polymerizing compound at a predetermined position within said column, said method including removing said viscous fluid from said column after polymerization of said packing medium.

26. A method according to claim 25, wherein said viscous fluid comprises glycerol.
